(19) United States
(12) Patent Application Publication
(10) Pub. No.: US 2004/0045825 A1
(43) Pub. Date: Mar. 11, 2004

(54) Cartridge for electrophoresis detection device and manufacturing method thereof

(75) Inventors: Chung-Fan Chiou, Hsinchu (TW); Chih-Wei Ho, Miaoli (TW); Bor-Iuan Jan, Pingtung (TW); Jian-Je Jian, Taipei (TW); Chien-Tsung Wu, Taichung (TW); Hsi-Hsin Shih, Taichung (TW)

Correspondence Address: SUGHRUE MION, PLLC, 2100 PENNSYLVANIA AVENUE, N.W., WASHINGTON, DC, 20037, US

(73) Assignee: INDUSTRIAL TECHNOLOGY RESEARCH INSTITUTE

(21) Appl. No.: 10/435,587

(22) Filed: May 12, 2003

(30) Foreign Application Priority Data
Sep. 10, 2002 (TW) 091120569

(51) Int. Cl. G01N 27/26

(52) U.S. Cl. 204/450; 204/600

(57) ABSTRACT

A cartridge for an electrophoresis detection device and a manufacturing method thereof. The cartridge includes a first member, a second member, and a capillary. The first member includes a first concave portion. The second member includes a second concave portion corresponding to the first concave portion. The second member is combined with the first member in a manner such that the second concave portion faces the first concave portion. The capillary is disposed in the first concave portion and the second concave portion in a manner such that it protrudes from the first and second members.

### BACKGROUND OF THE INVENTION

1. Field of the Invention

The invention relates to a cartridge and a manufacturing method thereof; in particular, to a cartridge for an electrophoresis detection device and a manufacturing method thereof.

2. Description of the Related Art

The value of electrophoresis in biochemistry has been recognized for some time in the analysis, for example, of proteins in serum as well as other body fluids. FIG. 1 shows a conventional gel electrophoresis apparatus 10. The apparatus 10 comprises a separation tank 11, and a power supply 12 electrically coupled thereto. During analysis, a sample is applied near one edge of a layer of gelatin carried on a flexible sheet, usually called a “gel” 13. The gel 13 is disposed in the separation tank 11, undergoes electrophoresis by the power supply 12, is stained and the density of the resulting pattern is measured to reveal the proteins contained in the sample.

Although gel electrophoresis is relatively inexpensive in terms of the supplies and equipment required to perform sample analyses, the technique requires skilled technicians and is time consuming, effectively resulting in a high cost per test and limiting the number of tests that can be performed using the technique.

Efforts have been made to automate electrophoresis in the clinical laboratories. For example, capillary electrophoresis is a more recent development and can be used to perform the type of electrophoresis separations presently performed with gels.

Automated forms of capillary electrophoresis analyzers are known in the art. For example, FIG. 2 shows a conventional capillary electrophoresis analyzer 20 described in U.S. Pat. No. 5,560,811. An electrophoresis separation plate 21 has a plurality of sample wells 22 at one end and a common buffer reservoir 23 at the other end. A first master electrode 25 is electrically connected to a cell electrode 26 in the sample wells 22. A second master electrode 27 is in the common buffer reservoir 23. Capillary electrophoresis columns 28 are mounted in the plate 21 such that there is electrical communication between the first master electrode 25 by way of the capillary electrophoresis column 28 when the sample wells 22 and the reservoir 23 are filled with electrically conductive liquid. In operation, current between the master electrodes permits electrophoresis of the sample from the sample well 22 to the reservoir 23.

Other automated capillary electrophoresis apparatuses are described in U.S. Pat. No. 6,132,582, U.S. Pat. No. 5,885,430, U.S. Pat. No. 6,118,127, U.S. Pat. No. 5,413,686.

None of the automated analyzers described, however, are suitable for routine clinical laboratory applications. Despite their automated nature, each requires considerable manual manipulation, such as preparation and placement of individual sample and buffer vials onto the analyzer, programming for the various analytical routines, and the like. Because only one sample can undergo electrophoresis and detection during each analysis cycle of the analyzers, the number of samples per unit time, or throughput, is severely restricted compared to the needs of most routine clinical laboratory work.

In view of the disadvantages of the conventional analyzers, the inventor of this invention has provided a new electrophoresis separation apparatus 100 as shown in FIG. 3. The apparatus 100 comprises a main portion 110 and a hand-held electrophoresis detection device 120. Since the hand-held electrophoresis detection device 120 is connected to the main portion 110 in a separable manner, it can be operated conveniently without the limitation of the location of the main portion 110. Thus, the detection can be performed more quickly and conveniently.

The main portion 110 controls a detection of the sample. The hand-held electrophoresis detection device 120 comprises a support 121, a cartridge 122, and a plurality of detection columns 123. The support 121 is used as a basic element of the device 120, and is electrically connected to the main portion 110. The cartridge 122 is disposed in the support 121 in a detachable manner, and is electrically connected to the support 122. After detection, the cartridge 122 can be replaced quickly such that contamination between the samples is avoided. The detection columns 123 are disposed on the cartridge 122, and the samples are attached thereto. Thus, the samples can be moved in the detection columns 123 to perform the detection.

In the electrophoresis separation apparatus 100, only the basic structure of the apparatus is described. However, the detailed structure of each element is not described, such as the structure of the cartridge and the manufacturing method thereof.

### SUMMARY OF THE INVENTION

In view of this, the invention provides a cartridge for an electrophoresis detection device and a manufacturing method thereof.

Accordingly, the invention provides a cartridge for an electrophoresis detection device. The cartridge comprises a first member and a second member. The first member comprises a first concave portion. The second member comprises a second concave portion corresponding to the first concave portion. The second member is combined with the first member in a manner such that the second concave portion faces the first concave portion.

In a preferred embodiment, the first member comprises a first protrusion and a third concave portion, formed on the first protrusion and communicating with the first concave portion. The second member comprises a second protrusion and a fourth concave portion, formed on the second protrusion and communicating with the second concave portion.

Furthermore, the first protrusion comprises a first end at which the third concave portion communicates with the first concave portion and a second end opposite the first end, and the width of the first end exceeds that of the second end, and the second protrusion comprises a third end at which the fourth concave portion communicates with the second concave portion and a fourth end opposite the third end, the width of the third end exceeding that of the fourth end.

In another preferred embodiment, the cartridge further comprises a capillary disposed in the first concave portion and the second concave portion in a manner such that the capillary protrudes from the first and second members.

Furthermore, one end of the capillary, protruding from the first and second members, is tapered.

Furthermore, the capillary comprises a plurality of through holes formed near an end protruding from the first and second members.

In another preferred embodiment, the cartridge further comprises an electrode disposed between the first and second members in a manner such that the electrode is exposed by the first and second members.

Furthermore, the first member comprises a fifth concave portion, and the second member comprises a sixth concave portion, and the electrode is disposed in the fifth concave portion and the sixth concave portion.

Furthermore, the first member comprises a seventh concave portion communicating with the first concave portion and the fifth concave portion, and the second member comprises an eighth concave portion communicating with the second concave portion and the sixth concave portion.

The invention provides a method for manufacturing a cartridge for an electrophoresis detection device. The method comprises the following steps. First, a first member, formed with an integral first concave portion, is formed. Then, a second member, formed with an integral second concave portion, is formed. Finally, the first and second members are combined in a manner such that the second concave portion faces the first concave portion.

It is understood that the first and second members may be formed by several manufacturing methods, for example, by injection molding.

The invention provides another method for manufacturing a cartridge for an electrophoresis detection device. The method comprises the following steps. First, a first member, formed with an integral first concave portion, is formed, and a second member, formed with an integral second concave portion, is formed. Then, a capillary is provided, and is disposed in the first concave portion. Finally, the first and second members are combined in a manner such that the second concave portion faces the first concave portion. Also, the capillary is disposed in the first concave portion and the second concave portion in a manner such that the capillary protrudes from the first and second members.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional gel electrophoresis apparatus;

FIG. 2 is a schematic view of a conventional capillary electrophoresis analyzer as described in U.S. Pat. No. 5,560,811;

FIG. 3 is a schematic view of a conventional electrophoresis separation apparatus;

FIG. 4a is a schematic view of a cartridge for an electrophoresis detection device as disclosed in a first embodiment of the invention;

FIG. 4b is a combined cartridge in FIG. 4a;

FIG. 5 is a flowchart of a method for manufacturing the cartridge in FIG. 4a;

FIG. 6a is a schematic view of a cartridge for an electrophoresis detection device as disclosed in a second embodiment of the invention;

FIG. 6b is a combined cartridge in FIG. 6a;

FIG. 7a is a variant embodiment of a capillary in FIG. 6a;

FIG. 7b is another variant embodiment of a capillary in FIG. 6a; and

FIG. 8 is a flowchart of a method for manufacturing the cartridge in FIG. 6a.

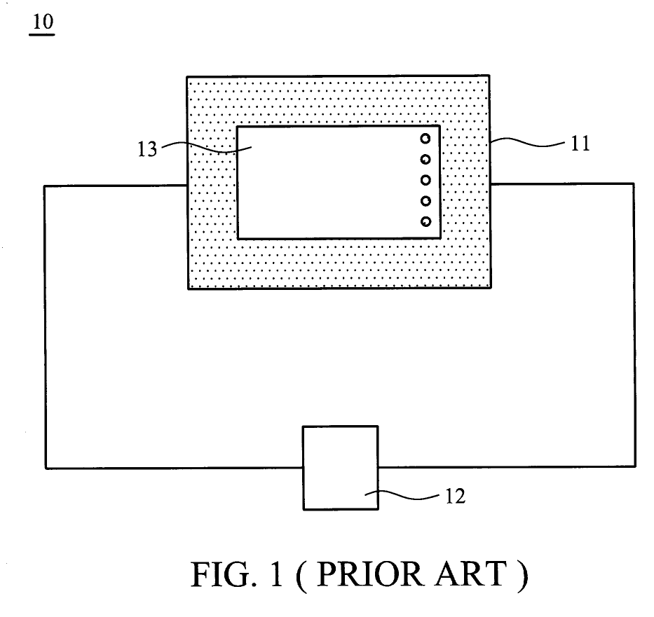

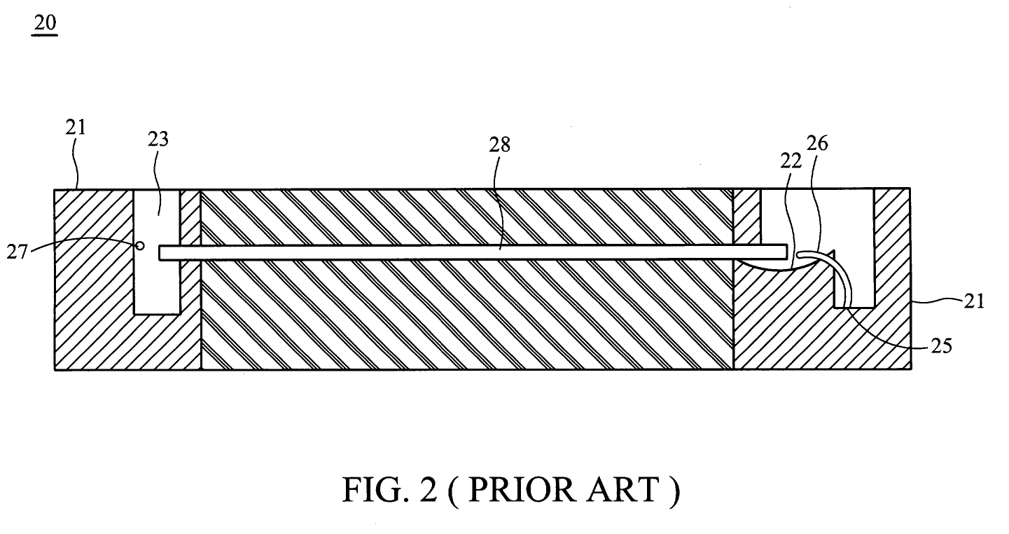

### DETAILED DESCRIPTION OF THE INVENTION

First Embodiment

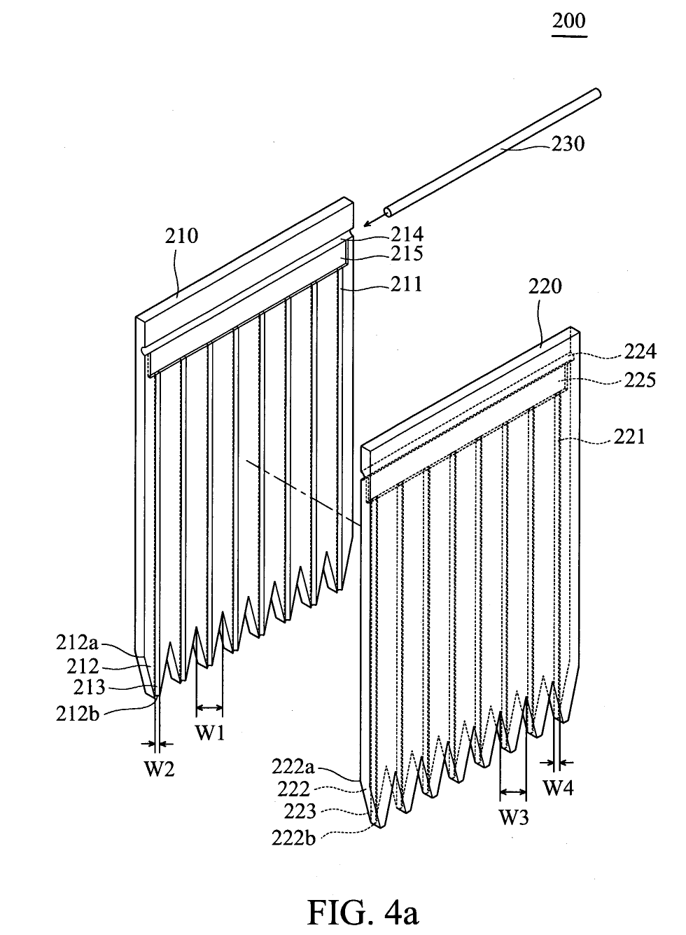

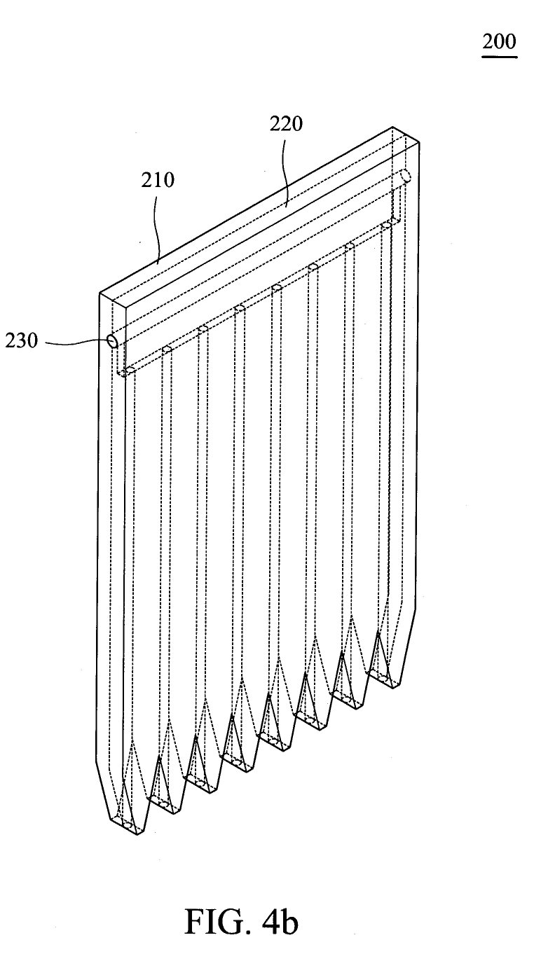

Referring to FIG. 4a and FIG. 4b, a cartridge for an electrophoresis detection device as disclosed in a first embodiment of the invention is shown. In this embodiment, the cartridge 200 comprises a first member 210, a second member 220, and an electrode 230.

The first member 210 comprises a plurality of first concave portions 211, a plurality of first protrusions 212, a plurality of third concave portions 213, a fifth concave portion 214, and a seventh concave portion 215. The first concave portions 211 are formed around the center portion of the first member 210. Each of the first protrusions 212 is formed at the lower portion of the first member 210, and corresponds to the first concave portions 211 respectively. Each of the third concave portions 213 is formed on the corresponding first protrusion 212, and communicates with the corresponding first concave portion 211 respectively. The fifth concave portion 214 is formed at the upper portion of the first member 210, and electrode 230 is disposed thereon. The seventh concave portion 215 communicates with the first concave portions 211 and the fifth concave portion 214, with a predetermined liquid disposed therein such that the liquid is in contact with the electrode 230.

The second member 220 comprises a plurality of second concave portions 221, a plurality of second protrusions 222, a plurality of fourth concave portions 223, a sixth concave portion 224, and an eighth concave portion 225. The second concave portions 221 are formed around the center portion of the second member 220. Each of the second protrusions 222 is formed at the lower portion of the second member 220, and corresponds to the second concave portions 221 respectively. Each of the fourth concave portions 223 is formed on the corresponding second protrusion 222, and communicates with the corresponding second concave portion 221 respectively. The sixth concave portion 224 is formed at the upper portion of the second member 220, and electrode 230 is disposed thereon. The eighth concave portion 225 communicates with the second concave portions 221 and the sixth concave portion 224, with a predetermined liquid disposed therein such that the liquid is in contact with the electrode 230.

It is understood that a plurality of channels, through which the samples flow, are formed between the first concave portions 211, the third concave portions 213 and the second concave portions 221, and the fourth concave portions 223 when the second member 220 is combined with the first member 210.

It is noted that in FIG. 4a, the first protrusion 212 comprises a first end 212a at which the third concave portion 213 communicates with the first concave portion 211 and a second end 212b opposite the first end 212a. The width W1 of the first end 212a exceeds the width W2 of the second end 212b. The second protrusion 222 comprises a third end 222a at which the fourth concave portion 223 communicates with the second concave portion 221 and a fourth end 222b opposite the third end 222a. The width W3 of the third end 222a exceeds the width W4 of the fourth end 222b. Thus, the tip end of the protrusion is narrower, such that the cartridge 220 is easily attached to the sample.

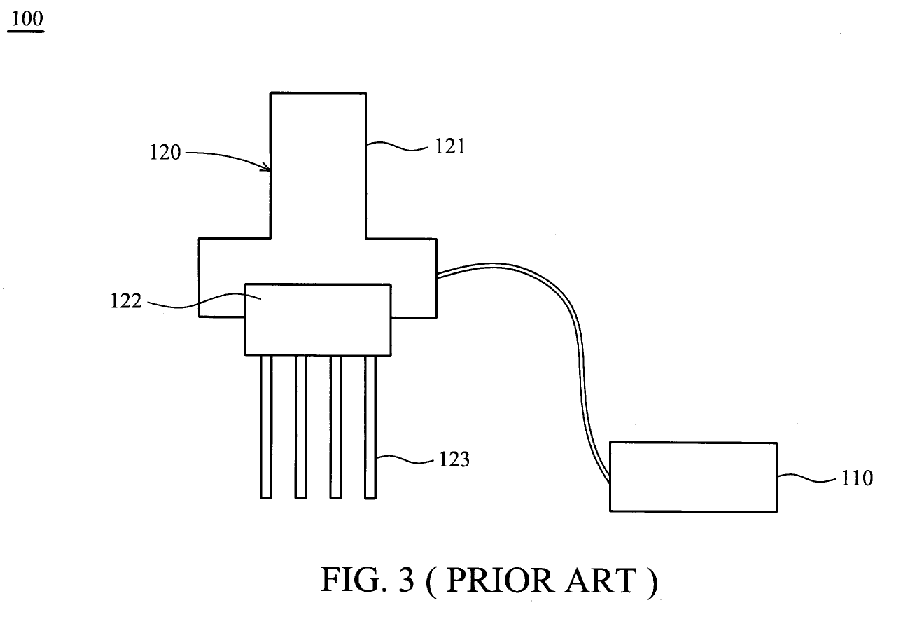

As shown in FIG. 4b, the electrode 230 is disposed between the first member 210 and the second member 220 in a manner such that the electrode 230 is exposed by the first member 210 and the second member 220. Thus, when the cartridge 200 is placed in the support 121 as shown in FIG. 3, the electrode 230 can be electrically connected with the support 121.

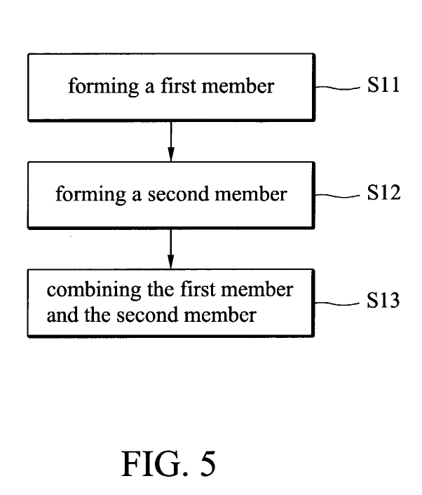

While the structure of the cartridge 200 is described as above, its manufacturing method is described hereinafter with reference to FIG. 5.

In step S11, a first member 210 as shown in FIG. 4a is formed, and the first concave portions 211 are integrally formed thereon. Then, in step S12, a second member 220 as shown in FIG. 4a is formed, whereon the second concave portions 221 are integrally formed. Finally, in step S13, the first member 210 and the second member 220 are combined in a manner such that the second concave portions 221 face the first concave portions 211. Also, the electrode 230 is located between the first member 210 and the second member 220 as shown in FIG. 4b.

It is noted that the first member 210 and the second member 220 may be formed by injection molding.

Furthermore, the first member 210 and the second member 220 may be of polymer.

Second Embodiment

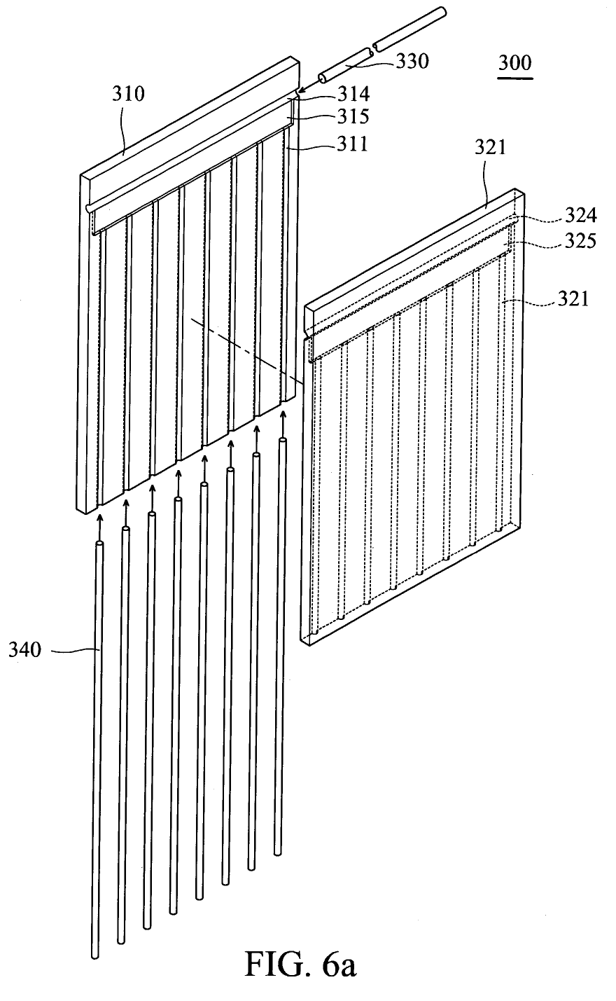

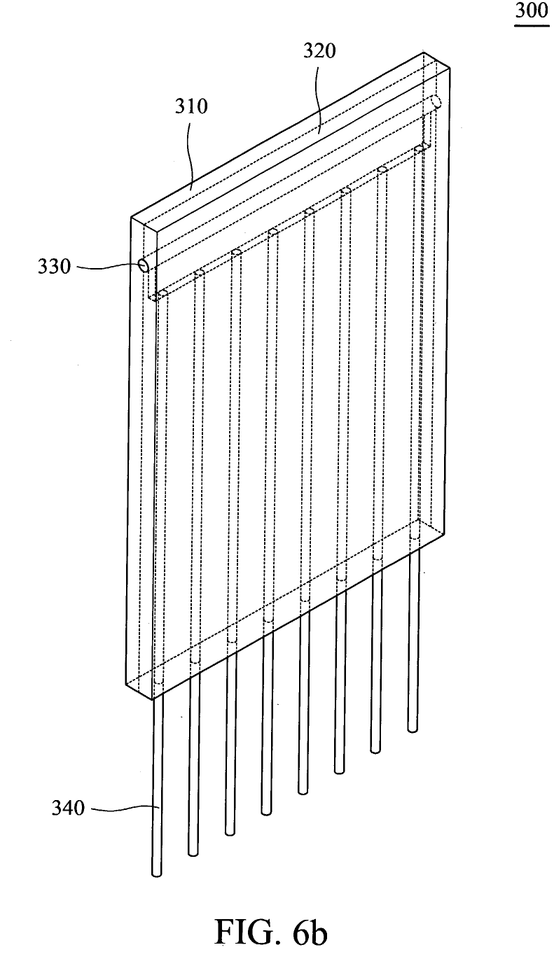

Referring to FIG. 6a and FIG. 6b, a cartridge for an electrophoresis detection device as disclosed in a second embodiment of the invention is shown. In this embodiment, the cartridge 300 comprises a first member 310, a second member 320, an electrode 330, and a plurality of capillaries 340.

The first member 310 comprises a plurality of first concave portions 311, a fifth concave portion 314, and a seventh concave portion 315. The first concave portions 311 are formed around the center portion of the first member 310. The fifth concave portion 314 is formed at the upper portion of the first member 310, and electrode 330 is disposed thereon. The seventh concave portion 315 communicates with the first concave portions 311 and the fifth concave portion 314, with a predetermined liquid disposed therein such that the liquid is in contact with the electrode 330.

The second member 320 comprises a plurality of second concave portions 321, a sixth concave portion 324, and an eighth concave portion 325. The second concave portions 321 are formed around the center portion of the second member 320. The sixth concave portion 324 is formed at the upper portion of the second member 320, and electrode 330 is disposed thereon. The eighth concave portion 325 communicates with the second concave portions 321 and the sixth concave portion 324, with a predetermined liquid disposed therein such that the liquid is in contact with the electrode 330.

As shown in FIG. 6b, the electrode 330 is disposed between the first member 310 and the second member 320 in a manner such that the electrode 330 is exposed by the first member 310 and the second member 320. Thus, when the cartridge 300 is placed in the support 121 as shown in FIG. 3, the electrode 330 is electrically connected with the support 121.

The capillaries 340 are used as the channels of the cartridge 300; that is, the attached samples flow therethrough. Each of the capillaries 340 is disposed in the first concave portion 311 and the second concave portion 321 in a manner such that it protrudes from the first member 310 and the second member 320.

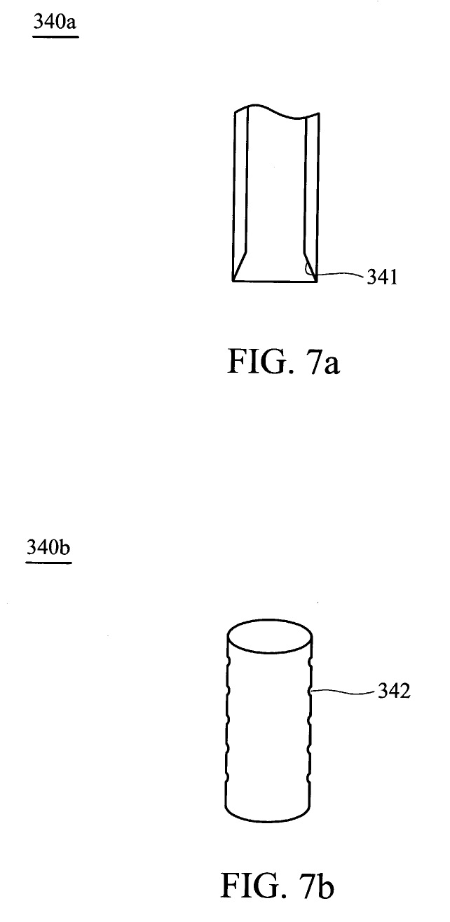

In addition, the structure of the capillary 340 can be changed to increase the volume of the attached sample. For example, as shown in FIG. 7a, one end, protruding from the first member 310 and the second member 320, of the capillary 340a forms a tapered portion 341. Thus, the area of the tip end of the capillary 340a is increased such that the volume of the attached sample can be increased. Alternatively, as shown in FIG. 7b, the cartridge 340b is formed with a plurality of through holes 342 near the end protruding from the first member 310 and the second member 320.

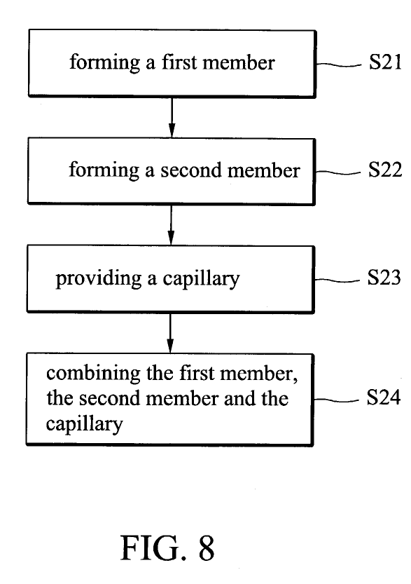

While the structure of the cartridge 300 is described above, its manufacturing method is described hereinafter with reference to FIG. 8.

In step S21, a first member 310 as shown in FIG. 6a is formed, with the first concave portions 311 integrally formed thereon. Then, in step S22, a second member 320 as shown in FIG. 6a is formed, with the second concave portions 321 integrally formed thereon. In step 23, a plurality of capillaries 340 as shown in FIG. 6a are provided in the first concave portions 321. Finally, in step S24, the first member 310 and the second member 320 are combined in a manner such that the second concave portions 321 face the first concave portions 311. Also, the electrode 330 and the capillaries 340 are located between the first member 310 and the second member 320 as shown in FIG. 6b.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cartridge for an electrophoresis detection device, comprising:
a first member comprising a first concave portion; and
a second member comprising a second concave portion corresponding to the first concave portion, wherein the second member is combined with the first member in a manner such that the second concave portion faces the first concave portion.

2. The cartridge as claimed in claim 1, wherein the first member comprises a first protrusion and a third concave portion, formed on the first protrusion and communicating with the first concave portion, and the second member comprises a second protrusion and a fourth concave portion, formed on the second protrusion and communicating with the second concave portion.

3. The cartridge as claimed in claim 2, wherein the first protrusion comprises a first end at which the third concave portion communicates with the first concave portion and a second end opposite the first end, and the width of the first end exceeds that of the second end, and the second protrusion comprises a third end at which the fourth concave portion communicates with the second concave portion and a fourth end opposite the third end, the width of the third end exceeding that of the fourth end.

4. The cartridge as claimed in claim 1, further comprising:
a capillary disposed in the first concave portion and the second concave portion in a manner such that the capillary protrudes from the first and second members.

5. The cartridge as claimed in claim 4, wherein one end of the capillary, protruding from the first and second members, is tapered.

6. The cartridge as claimed in claim 4, wherein the capillary is formed with a plurality of through holes near an end protruding from the first and second members.

7. The cartridge as claimed in claim 1, further comprising:
an electrode disposed between the first and second members in a manner such that the electrode is exposed by the first and second members.

8. The cartridge as claimed in claim 7, wherein the first member comprises a fifth concave portion, and the second member comprises a sixth concave portion, and the electrode is disposed in the fifth concave portion and the sixth concave portion.

9. The cartridge as claimed in claim 8, wherein the first member comprises a seventh concave portion communicating with the first concave portion and the fifth concave portion, and the second member comprises an eighth concave portion communicating with the second concave portion and the sixth concave portion.

10. A method for manufacturing a cartridge for an electrophoresis detection device, comprising:
forming a first member formed with an integral first concave portion;
forming a second member formed with an integral second concave portion; and
combining the first and second members in a manner such that the second concave portion faces the first concave portion.

11. The method as claimed in claim 10, wherein the first member is formed with an integral first protrusion and a third concave portion, located on the first protrusion and communicating with the first concave portion, and the second member formed with an integral second protrusion and a fourth concave portion, located on the second protrusion and communicating with the second concave portion.

12. The method as claimed in claim 10, further comprising providing an electrode located between the first and second members.

13. The method as claimed in claim 10, wherein the first member is formed by injection molding.

14. The method as claimed in claim 10, wherein the second member is formed by injection molding.

15. A method for manufacturing a cartridge for an electrophoresis detection device, comprising:
forming a first member formed with an integral first concave portion;
forming a second member formed with an integral second concave portion;
providing a capillary;
disposing the capillary in the first concave portion; and
combining the first and second members in a manner such that the second concave portion faces the first concave portion, wherein the capillary is disposed in the first concave portion and the second concave portion in a manner such that the capillary protrudes from the first and second members.

16. The method as claimed in claim 15, further comprising:
providing an electrode between the first and second members.

17 The method as claimed in claim 15, wherein the first member is formed by injection molding.

18. The method as claimed in claim 15, wherein the second member is formed by injection molding.
